(19) United States
(12) Patent Application Publication
(10) Pub. No.: US 2025/0055036 A1
(43) Pub. Date: Feb. 13, 2025

(54) Lithium Secondary Battery

(71) Applicant: SK On Co., Ltd., Seoul (KR)

(72) Inventors: Yeon Hwa SONG, Daejeon (KR); Jae Ram KIM, Daejeon (KR); Ji Won NA, Daejeon (KR); Jae Yun MIN, Daejeon (KR); Sang Won BAE, Daejeon (KR); Ji Hee BAE, Daejeon (KR); Ki Joo EOM, Daejeon (KR); Myung Ro LEE, Daejeon (KR); Yong Seok LEE, Daejeon (KR); Jae Yeong LEE, Daejeon (KR); Hyun Joong JANG, Daejeon (KR)

(21) Appl. No.: 18/794,257

(22) Filed: Aug. 5, 2024

(30) Foreign Application Priority Data
Aug. 8, 2023 (KR) 10-2023-0103258

(51) Int. Cl. H01M 10/0569; H01M 4/02; H01M 4/38; H01M 4/583; H01M 10/052; H01M 10/0567; H01M 10/0568

(52) U.S. Cl. CPC H01M 10/0569; H01M 4/386; H01M 4/583; H01M 10/052; H01M 10/0567; H01M 10/0568; H01M 2004/027; H01M 2004/028; H01M 2300/0034; H01M 2300/004

(57) ABSTRACT

The present disclosure relates to a high energy density lithium secondary battery having significantly improved high-temperature storage characteristics and lifespan characteristics, which are problematic when a silicon-based negative electrode active material is applied. Specifically, a lithium secondary battery according to an exemplary embodiment includes a positive electrode; a negative electrode facing the positive electrode and including a silicon-based negative electrode active material; and a non-aqueous electrolyte containing a non-aqueous organic solvent including a di-fluoro-based organic solvent and a lithium salt, wherein a content of the di-fluoro-based organic solvent is 5 to 20 vol % with respect to a total volume of the non-aqueous organic solvent.

### CROSS-REFERENCE TO RELATED APPLICATIONS

This application claims priority under 35 U.S.C. § 119 to Korean Patent Application N0.10-2023-0103258, filed on Aug. 8, 2023, in the Korean Intellectual Property Office, the disclosure of which is incorporated herein by reference in its entirety.

### TECHNICAL FIELD

The following disclosure relates to a lithium secondary battery including a silicon-based negative electrode material.

### BACKGROUND

Recently, as a demand for high-capacity lithium secondary batteries has rapidly increased, attempts at applying a silicon-based negative electrode material having a capacity of 10 times or more than a graphite-based negative electrode material according to the related art are continuously being made. However, when the silicon-based negative electrode material is used, as an electrolyte is decomposed during initial charging, a solid electrolyte interphase (SEI) layer is accumulated on a surface of a negative electrode active material, and accordingly, an energy density is reduced. As a result, there is a limitation in that the theoretical amount of the battery cannot be sufficiently realized and the lifespan characteristics are deteriorated.

Various attempts have been made to solve these problems, but the improvement effect on the above limitation is not sufficient, and even when there are some improvements, a new alternative is needed due to problems such as deterioration of high-temperature storage characteristics or rapid charging lifespan characteristics.

### SUMMARY

An embodiment of the present disclosure is directed to providing a lithium secondary battery that simultaneously satisfies a high energy density, excellent high-temperature storage characteristics, and rapid charging lifespan characteristics.

The lithium secondary battery of the present disclosure may be widely applied in green technology fields such as an electric vehicle, a battery charging station, and solar power generation and wind power generation using other batteries. In addition, the lithium secondary battery of the present disclosure may be used in an eco-friendly electric vehicle, a hybrid vehicle, and the like to prevent climate change by suppressing air pollution and greenhouse gas emissions.

In one general aspect, a lithium secondary battery includes a positive electrode; a negative electrode facing the positive electrode and including a silicon-based negative electrode active material; and a non-aqueous electrolyte containing a non-aqueous organic solvent including a di-fluoro-based organic solvent and a lithium salt, wherein a content of the di-fluoro-based organic solvent is 5 to 20 vol % with respect to a total volume of the non-aqueous organic solvent.

The silicon-based negative electrode active material may be Si, SiOₓ (O<x<2), Si/C, SiO/C, or a combination thereof.

The silicon-based negative electrode active material may be included in the negative electrode in an amount of 5 to 20 wt %.

The non-aqueous organic solvent may further include a linear carbonate-based solvent and a cyclic carbonate-based solvent.

The linear carbonate-based solvent may be one or two or more selected from dimethyl carbonate, diethyl carbonate, ethyl methyl carbonate, and methyl propyl carbonate.

The cyclic carbonate-based solvent may be one or two or more selected from ethylene carbonate, propylene carbonate, and trimethylene carbonate.

The linear carbonate-based solvent and the di-fluoro-based organic solvent may be contained in a volume ratio of 1:0.1 to 1:1.

The non-aqueous electrolyte may further contain an additive containing fluoroethylene carbonate.

The fluoroethylene carbonate may be contained in an amount of more than 3 wt % and 10 wt % or less with respect to a total weight of the non-aqueous organic solvent.

The fluoroethylene carbonate and the di-fluoro-based organic solvent may be contained in a volume ratio of 1:1 to 1:5.

The di-fluoro-based organic solvent may be a di-fluoro-based acetate solvent.

The di-fluoro-based organic solvent may be represented by the following Chemical Formula 1:

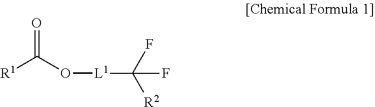

wherein
R¹ is C₁-C₆ alkyl or C₆-C₁₂ aryl;
L¹ is a single bond, C₁-C₆ alkylene, or C₂-C₆ alkenylene; and
R² is hydrogen or C₁-C₆ alkyl.

The di-fluoro-based organic solvent may be represented by the following Chemical Formula 2:

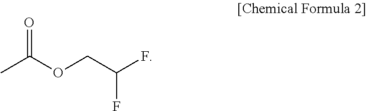

The lithium salt may be one or two or more selected from LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiN(CₓF₂ₓ₊₁SO₂) (CyF_{2y+1}SO₂) (where x and y are natural numbers), LiCl, LiI, and LiB(C₂O₄)₂.

A capacity retention rate of the lithium secondary battery may be 80% or more when rapid charge and discharge cycles are repeated 300 times at a temperature of 25° C., and a capacity retention rate of the lithium secondary battery may be 80% or more when left for 20 weeks at a temperature of 60° C.

Other features and aspects will be apparent from the following detailed description, the drawings, and the claims.

### DETAILED DESCRIPTION OF EMBODIMENTS

Unless otherwise defined, all the technical terms and scientific terms used in the present specification have the same meanings as commonly understood by those skilled in the art to which the present disclosure pertains. The terms used in the description of the present specification are merely used to effectively describe a specific exemplary embodiment, and are not intended to limit the present disclosure.

Unless the context clearly indicates otherwise, singular forms used in the present specification may be intended to include plural forms.

In addition, a numerical range used in the present specification includes upper and lower limits and all values within these limits, increments logically derived from a form and span of a defined range, all double limited values, and all possible combinations of the upper and lower limits in the numerical range defined in different forms. Unless otherwise specifically defined in the present specification, values out of the numerical range that may occur due to experimental errors or rounded values also fall within the defined numerical range.

In the present specification, the expression “comprise(s)” is intended to be an open-ended transitional phrase having an equivalent meaning to “include(s),” “contain(s),” “have (has),” and “are (is) characterized by,” and does not exclude elements, materials, or steps, all of which are not further recited herein.

Hereinafter, the present disclosure will be described in detail. However, this is only illustrative, and the present disclosure is not limited to specific exemplary embodiments which are illustratively described by the present disclosure.

In order to meet the required performance of next-generation lithium batteries, attempts at applying a silicon-based negative electrode material having a capacity of 10 times or more than the conventional graphite-based negative electrode material are continuously being made. However, in the related art, when a silicon-based negative electrode material is used, the theoretical capacity of the battery cannot be sufficiently realized and the lifespan characteristics are deteriorated, and when attempts are made to solve these problems, there is a limitation in that high-temperature storage characteristics and rapid charge and discharge characteristics are deteriorated.

The present disclosure may provide a lithium secondary battery that includes a non-aqueous electrolyte having a specific composition and thus has improved high-temperature storage characteristics and lifespan characteristics even when a silicon-based negative electrode material is applied.

Specifically, a lithium secondary battery according to the present disclosure includes a positive electrode; a negative electrode facing the positive electrode and including a silicon-based negative electrode active material; and a non-aqueous electrolyte containing a non-aqueous organic solvent including a di-fluoro-based organic solvent and a lithium salt, wherein a content of the di-fluoro-based organic solvent is 5 to 20 vol % with respect to a total volume of the non-aqueous organic solvent.

As the lithium secondary battery according to the present disclosure satisfies the above configuration combination, the lithium secondary battery according to the present disclosure may simultaneously satisfy a high energy density and excellent high-temperature storage characteristics and lifespan characteristics. Without being bound by a specific theory, as an example, when the di-fluoro-based organic solvent is contained in an amount of less than 5%, high-temperature storage characteristics and lifespan characteristics of the lithium secondary battery may be deteriorated, and when the di-fluoro-based organic solvent is contained in an amount of more than 20%, rapid charging lifespan characteristics may be deteriorated.

Specifically, the di-fluoro-based organic solvent may be, for example, 5 vol % or more, 6 vol % or more, 7 vol % or more, 8 vol % or more, 9 vol % or more, 10 vol % or more, 12 vol % or more, or 13 vol % or more, and 20 vol % or less, 19 vol % or less, 18 vol % or less, 17 vol % or less, 16 vol % or less, 15 vol % or less, 14 vol % or less, or 13 vol % or less, with respect to a total volume of the non-aqueous organic solvent.

The di-fluoro-based organic solvent may be a di-fluoro-based acetate solvent, and specifically, may be represented by the following Chemical Formula 1:

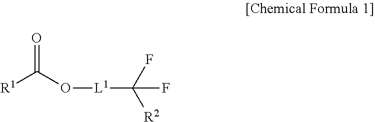

wherein
R¹ is C₁-C₆ alkyl or C₆-C₁₂ aryl;
L¹ is a single bond, C₁-C₆ alkylene, or C₂-C₆ alkenylene; and
R² is hydrogen, C₁-C₆ alkyl, or C₂-C₆ alkenyl.

As an example, in Chemical Formula 1, R¹ may be C₁-C₆ alkyl or C₁-C₃ alkyl, and more specifically, methyl or ethyl.

As an example, in Chemical Formula 1, L¹ may be C₁-C₆ alkylene or C₁-C₃ alkylene, and more specifically, methyl or ethyl.

As an example, in Chemical Formula 1, R² may be hydrogen.

More specifically, the di-fluoro-based organic solvent may be represented by the following Chemical Formula 2:

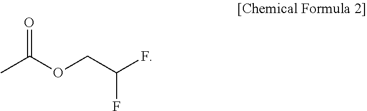

The non-aqueous organic solvent according to an exemplary embodiment may further include a linear carbonate-based solvent and a cyclic carbonate-based solvent.

The linear carbonate-based solvent may be, for example, one or two or more selected from dimethyl carbonate (DMC), diethyl carbonate (DEC), ethyl methyl carbonate (EMC), and methyl propyl carbonate (MPC), but is not limited thereto.

The cyclic carbonate-based solvent may be, for example, one or two or more selected from ethylene carbonate, propylene carbonate, and trimethylene carbonate, and preferably, may be propylene carbonate. When propylene carbonate is contained, high-temperature storage characteristics may be further improved when combined with other components.

The linear carbonate-based solvent and the di-fluoro-based organic solvent may be contained in a volume ratio of 1:0.1 to 1:1, 1:0.1 to 0.5, or 1:0.1 to 0.3. When the above-described range satisfied, is lifespan characteristics and high-temperature storage characteristics during rapid charging may be further improved when combined with other components.

The non-aqueous electrolyte according to an exemplary embodiment may further contain an additive. The additive may be a fluorine-substituted carbonate-based compound, specifically, a fluorine-substituted cyclic carbonate-based compound, for example, fluoroethylene carbonate (FEC), difluoroethylene carbonate (DFEC), or a combination thereof, and preferably fluoroethylene carbonate (FEC). When fluoroethylene carbonate is contained, an energy density and lifespan characteristics of the lithium secondary battery according to an exemplary embodiment may be further improved.

When the non-aqueous electrolyte according to an exemplary embodiment further contains fluoroethylene carbonate, the fluoroethylene carbonate may be contained in an amount of 3 wt % to 10 wt %, more than 3 wt % and 10 wt % or less, 3.5 wt % to 10 wt %, 4 wt % to 10 wt %, or 4 wt % to 7 wt %, with respect to a total weight of the non-aqueous electrolyte, and a capacity retention rate during rapid charging may be further improved.

In addition, the fluoroethylene carbonate and the di-fluoro-based organic solvent may be contained in a volume ratio of 1:1 to 5, 1:1 to 4, or 1:1 to 3. When the above-described range is satisfied, high-temperature storage characteristics and lifespan characteristics may be simultaneously further improved.

The lithium salt may be, but is not limited to, one or two or more selected from LiPF₆, LiBF₄, LiClO₄, LiSbF₆, LiASF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiN(CₓF₂ₓ₊₁SO₂) (CyF_{2y+1}SO₂) (where x and y are natural numbers), LiCl, LiI, and LiB(C₂O₄)₂.

In the lithium secondary battery according to an exemplary embodiment, the negative electrode may include a negative electrode current collector and a negative electrode active material layer formed on the negative electrode current collector.

As a non-limiting example, the negative electrode current collector may be selected from a foil formed of copper, gold, nickel, a copper alloy, or a combination thereof.

The negative electrode active material layer according to an exemplary embodiment may include a silicon-based negative electrode active material, and the silicon-based negative electrode active material may be, for example, silicon (Si), a silicon oxide (SiOₓ, O<x<2), a silicon-carbon composite (Si/C), a silicon oxide-carbon composite (SiO/C), or a combination thereof, and specifically, may be Si or Si/C.

The negative electrode active material layer may further include a carbon-based negative electrode active material, and may buffer an electrode expansion phenomenon while increasing capacity characteristics of the lithium secondary battery. The carbon-based negative electrode active material may be, for example, soft carbon, hard carbon, artificial graphite, natural graphite, expanded graphite, carbon fibers, carbon black, carbon nanotubes, acetylene black, Ketjen black, graphene, fullerene, activated carbon, mesocarbon microbeads, or a combination thereof.

The silicon-based negative electrode active material may be contained in an amount of 5 to 20 wt %, 5 to 15 wt %, or 10 to 15 wt %, with respect to a total weight of the negative electrode. In addition, when a carbon-based negative electrode active material is further contained, the silicon-based negative electrode active material and the carbon-based negative electrode active material may be contained in a weight ratio of 1:0.05 to 0.5, 1:0.05 to 0.3, or 1:0.1 to 0.3.

The negative electrode may be produced by adding a solvent, and if necessary, a binder, a conductive agent, a dispersant, or the like, to a negative electrode active material.

As the conductive agent, carbon black such as acetylene black, Ketjen black, channel black, furnace black, lamp black, or thermal black; a conductive fiber such as a carbon fiber or a metal fiber; metal powder such as carbon fluoride powder, aluminum powder, or nickel powder; a carbon nanotube such as a multi-walled carbon nanotube (MWCNT) or a single-walled carbon nanotube (SWCNT); a conductive whisker such as zinc oxide or potassium titanate; a conductive metal oxide such as titanium oxide; and a conductive material such as a polyphenylene derivative may be used. The conductive agent is not particularly limited as long as it has conductivity without causing a chemical change in a battery.

The binder is not limited as long as it serves to adhere negative electrode active material particles to each other and the negative electrode active material to the negative electrode current collector, and specifically, may be an aqueous binder. The aqueous binder may be polyvinylidene fluoride (PVDF), polyvinyl alcohol, carboxyl methyl cellulose (CMC), starch, hydroxypropylcellulose, regenerated cellulose, polyvinylpyrrolidone, tetrafluoroethylene, polyethylene, polypropylene, an ethylene-propylene-diene polymer (EPDM), a sulfonated-EPDM, styrene-butadiene rubber (SBR), fluoro rubber, and various copolymers thereof, and specifically, the binder may be carboxyl methyl cellulose (CMC), styrene-butadiene rubber (SBR), or a combination thereof.

In the lithium secondary battery according to an exemplary embodiment, the positive electrode may include a positive electrode current collector and a positive electrode active material layer formed on the positive electrode current collector, and the positive electrode active material layer may be produced by adding a solvent, and if necessary, a binder, a conductive agent, a dispersant, or the like, to a positive electrode active material.

As a non-limiting example, the positive electrode current collector may be a foil formed of aluminum, nickel, or a combination thereof.

As the positive electrode active material, a positive electrode active material commonly used in the art may be used. The positive electrode active material may be, for example, a lithium metal oxide containing a metal element such as nickel, cobalt, manganese, or aluminum, and non-limiting examples thereof include, but are not limited to, lithium composite oxide (LiCoO₂), spinel crystalline lithium manganese composite oxide (LiMn₂O₄), lithium manganese composite oxide (LiMnO₂), lithium nickel composite oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium composite oxide (LiNbO₂), lithium iron composite oxide (LiFeO₂), lithium magnesium composite oxide (LiMgO₂), lithium copper composite oxide (LiCuO₂), lithium zinc composite oxide (LiZnO₂), lithium molybdenum composite oxide (LiMOO₂), lithium tantalum composite oxide (LiTaO₂), lithium tungsten composite oxide (LiWO₂), lithium permanganate-nickel-cobalt composite oxide (xLi₂MnO₃ (1−x) LiMn1-y-zNiyCozO₂), lithium-nickel-cobalt-aluminum composite oxide (LiNi_{0.8}Co_{0.15}Al_{0.05}O₂), lithium-nickel-cobalt-manganese composite oxide (LiNi_{0.33}Co_{0.33}Mn_{0.33}O₂, LiNi_{0.4}Co_{0.2}Mn_{0.4}O₂, LiNi_{0.5}CO_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂, or LiNi_{0.88}Co_{0.1}Mn_{0.02}O₂), and oxide manganese nickel (LiNi_{0.5}Mn_{1.5}O₄).

In particular, the electrolyte for a lithium secondary battery according to an exemplary embodiment has excellent miscibility with a high-capacity positive electrode active material, for example, high-nickel lithium metal oxide (80 mol % or more of nickel). When a high-capacity positive electrode active material is used, chemical stability, for example, a capacity retention rate at room temperature, may be relatively deteriorated. However, in the case of the lithium secondary battery according to an exemplary embodiment, even when a high-capacity positive electrode active material is used, an excellent capacity retention rate at room temperature may be implemented because the electrolyte described above is contained. Therefore, the lithium secondary battery according to an exemplary embodiment may implement excellent lifespan characteristics while maintaining a high capacity.

As the conductive agent, carbon black such as acetylene black, Ketjen black, channel black, furnace black, lamp black, or thermal black; a conductive fiber such as a carbon fiber or a metal fiber; metal powder such as carbon fluoride powder, aluminum powder, or nickel powder; a carbon nanotube such as a multi-walled carbon nanotube (MWCNT) or a single-walled carbon nanotube (SWCNT); a conductive whisker such as zinc oxide or potassium titanate; a conductive metal oxide such as titanium oxide; and a conductive material such as a polyphenylene derivative may be used. The conductive agent is not particularly limited as long as it has conductivity without causing a chemical change in a battery.

The binder is not limited as long as it serves to adhere positive electrode active material particles to each other and the positive electrode active material to the positive electrode current collector, and specifically, may be an organic binder. The organic binder can be polyvinylidene fluoride (PVDF), styrene butadiene rubber (SBR), polytetrafluoroethylene, polyvinylidene fluoride/hexafluoropropylene copolymer, polyacrylonitrile, polymethylmethacrylate and various copolymers thereof. Specifically, the binder may be polyvinylidene fluoride (PVDF).

As the configuration combination described above is satisfied, the lithium secondary battery according to the present disclosure has excellent rapid charging lifespan characteristics and high-temperature storage characteristics.

Specifically, a capacity retention rate of the lithium secondary battery according to an exemplary embodiment may be 75% or more, 80% or more, 75% to 95%, or 80% to 95%, when rapid charge and discharge cycles are repeated 300 times at a temperature of 25° C.

In addition, a capacity retention rate of the lithium secondary battery according to an exemplary embodiment may be 75% or more, 80% or more, 85% or more, 75% to 95%, 80% to 95%, or 85% to 95%, when left for 20 weeks at a temperature of 60° C.

In addition, a capacity retention rate of the lithium secondary battery according to an exemplary embodiment may be 75% or more, 80% or more, 85% or more, 75% to 95%, 80% to 95%, or 85% to 95%, when left for 24 weeks at a temperature of 60° C.

Hereinafter, examples of the present disclosure will be further described with reference to specific experimental examples. The examples and comparative examples included in the experimental examples are merely illustrative of the present disclosure and do not limit the scope of the of the accompanying claims, and it is obvious to those skilled in the art that various modifications and alterations may be made without departing from the spirit and scope of the present disclosure, and it is obvious that these modifications and alterations are within the accompanying claims.

### [Methods for Evaluating Physical Properties]

### (1) Rapid Charging Lifespan Characteristics

The rapid charging lifespan characteristics of the lithium secondary batteries produced in examples and comparative examples at room temperature (25° C.) were evaluated. A constant voltage charge was performed to reach SOC82 within 17 minutes at 25° C. Thereafter, a constant current discharge was performed at 0.3 C-rate until SOC10 was reached (SOC10 CC cut-off). The charge and discharge were regarded as one cycle, and 300 cycles were performed. Thereafter, a capacity retention rate (%) was calculated as a percentage of a value obtained by dividing a discharge capacity in 300 cycles by a discharge capacity in one cycle, and lifespan characteristics during rapid charging was evaluated.

### (2) High-Temperature Storage Characteristics

The lithium secondary batteries produced in examples and comparative examples were charged under conditions of CC/CV, 1/3 C, 4.2 V, 0.05 C CUT-OFF and stored in an oven at 60° C. for 24 weeks, and then the discharge capacities were compared and analyzed at 4-week intervals. Specifically, each of the lithium secondary batteries was discharged under conditions of 1/3 C, 2.5 V CUT-OFF, charged under conditions of CC, 1/3 C, 4.2 V, 0.05 C CUT-OFF, and discharged again under conditions of CC, 1/3 C, 2.5 V CUT-OFF to obtain a discharge capacity, a capacity retention rate (%) was calculated as a percentage of a value obtained by dividing the discharge capacity by a discharge capacity during standard charging and discharging, and high-temperature storage characteristics were evaluated.

### (3) Energy Density (Wh/L)

The energy density was calculated by dividing a unit cell energy (Wh) value of the lithium secondary battery of each of examples and comparative examples by a total volume (L) of the lithium secondary battery. Here, the unit cell energy was measured by integrating a 0.3 C discharge graph.

### Example 1

### Preparation of Non-Aqueous Electrolyte

As shown in Table 1, a non-aqueous organic solvent was obtained by mixing propylene carbonate (PC), ethyl methyl carbonate (EMC), and difluoroethyl acetate (DFEA) in a volume ratio of 25:60:15. LiPF₆ was dissolved in the non-aqueous organic solvent to prepare a 1.1 M LiPF₆ solution, and then fluoroethylene carbonate (FEC), which is an additive, was added and mixed so that the amount thereof was 4.5 wt %, thereby preparing a non-aqueous electrolyte of Example 1.

### Production of Lithium Secondary Battery

Li[Ni_{0.88}Co_{0.1}Mn_{0.02}]O₂ as a positive electrode active material, polyvinylidene fluoride (PVdF) as a binder, and multi-walled carbon nanotubes (as a conductive agent were mixed in a weight ratio of 98.78:0.75:0.6, and then, N-methyl-2-pyrrolidone was dispersed in the mixture, thereby preparing a positive electrode slurry. The slurry was coated on an aluminum foil having a thickness of 12 μm, and the aluminum foil coated with the slurry was dried and rolled, thereby producing a positive electrode.

Single-walled carbon nanotubes (SWCNTs) as a conductive agent, styrene-butadiene rubber (SBR) as a binder, and carboxymethylcellulose (CMC) as a thickener were mixed in a weight ratio of 0.25:2.4:1.2 with respect to 100 parts by weight of a negative electrode active material containing graphite and a Si negative electrode active material in a weight ratio of 89:11, and then the mixture was dispersed in water, thereby preparing a negative electrode slurry. The slurry was coated on a copper foil having a thickness of 8 μm, and the copper foil coated with the slurry was dried and rolled, thereby producing a negative electrode.

The produced positive electrode and negative electrode were each notched to a predetermined size and stacked, and a film separator formed of polyethylene (PE) having a thickness of 13 μm was stacked, and then, tab portions of the positive electrode and the negative electrode were welded, respectively. The welded positive electrode/separator/negative electrode assembly was placed in a pouch and three sides except one side into which an electrolyte was injected were sealed to form a cell, and the electrolyte prepared above was injected, thereby producing a lithium secondary battery. Thereafter, a pre-charge was performed at a current (2.5 A) equivalent to 0.25 C for 36 minutes. After 1 hour, degassing was performed, aging was performed for 24 hours or longer, and then, chemical charge and discharge were performed (charge conditions: CC-CV, 0.2 C, 4.2 V, 0.05 C CUT-OFF/discharge conditions: CC, 0.2 C, 2.5 V CUT-OFF). Thereafter, standard charge and discharge were performed (charge conditions: CC-CV, 0.5 C, 4.2 V, 0.05 C CUT-OFF/discharge conditions: CC, 0.5 C, 2.5 V CUT-OFF).

Thereafter, the lithium secondary battery performance was evaluated by the methods described in the methods for evaluating physical properties, and the results thereof were shown in Tables 1 and 2.

### Examples 2 and 3

The same procedure as in Example 1 was performed except that the volume ratio of the organic solvent was changed as shown in Table 1 in the preparation of the non-aqueous electrolyte.

### Example 4

The same procedure as in Example 1 was performed except that fluoroethylene carbonate (FEC) was added so that the amount thereof was 15 wt % with respect to the total weight of the electrolyte as shown in Table 1 in the preparation of the non-aqueous electrolyte.

### Comparative Examples 1 to 3

The same procedure as in Example 1 was performed except that the volume ratio of the organic solvent was changed as shown in Table 1 in the preparation of the non-aqueous electrolyte.

In Table 1, each of the contents of PC, EMC, DEC, and DFEA refers to a volume ratio with respect to the total volume of the non-aqueous organic solvent, and the content of FEC refers to wt % with respect to the total weight of the non-aqueous electrolyte.

TABLE 1

| | | | | | | Rapid |
|---|---|---|---|---|---|---|
| | | | | | | charging |
| | Non-aqueous | | | | | lifespan |
| | organic | | | | Energy | characteristics |
| | solvent | | | Additive | density | (300 |
| | PC | EMC | DFEA | FEC | (Wh/L) | cycle, %) |
| Example 1 | 25 | 60 | 15 | 4.5 wt % | 709.4 | 83.5 |
| | vol % | vol % | vol % | | | |
| Example 2 | 25 | 65 | 10 | 4.5 wt % | 710.3 | 84.6 |
| | vol % | vol % | vol % | | | |
| Example 3 | 25 | 68 | 7 | 4.5 wt % | 711.8 | 85.8 |
| | vol % | vol % | vol % | | | |
| Example 4 | 25 | 60 | 15 | 15 wt % | 717.6 | 86.9 |
| | vol % | vol % | vol % | | | |
| Comparative | 25 | 45 | 30 | 4.5 wt % | 711.6 | 70.5 |
| Example1 | vol % | vol % | vol % | | | |
| Comparative | 25 | 30 | 45 | 4.5 wt % | 713.8 | 46.0 |
| Example 2 | vol % | vol % | vol % | | | |
| Comparative | 25 | 72 | 3 | 4.5 wt % | 710.5 | 84.8 |
| Example 3 | vol % | vol % | vol % | | | |

As shown in Table 1, in all the lithium secondary batteries according to the examples, it was confirmed that an excellent energy density and excellent lifespan characteristics during rapid charging were simultaneously satisfied. On the other hand, in the case of the lithium secondary batteries according to Comparative Examples 1 and 2, the lifespan characteristics during rapid charging were significantly deteriorated.

TABLE 2

| | High-temperature storage characteristics (%) | | | | | |
|---|---|---|---|---|---|---|
| | 4 | 8 | 12 | 16 | 20 | 24 |
| | weeks | weeks | weeks | weeks | weeks | weeks |
| Example 1 | 95.1% | 93.2% | 91.6% | 90.3% | 88.7% | 86.9% |
| Example 2 | 94.9% | 92.9% | 91.3% | 89.8% | 88.2% | 86.5% |
| Example 3 | 94.9% | 93.0% | 91.4% | 90.0% | 88.3% | 86.6% |
| Example 4 | 94.7% | 93.6% | 91.7% | 90.7% | 89.2% | — |
| Comparative | 94.6% | 92.6% | 89.5% | 86.8% | 85.2% | 82.1% |
| Example 1 | | | | | | |
| Comparative | 95.0% | 93.0% | 89.8% | 87.5% | 85.9% | 83.8% |
| Example 2 | | | | | | |
| Comparative | 94.6% | 91.5% | 88.7% | 86.2% | 83.8% | 80.9% |
| Example 3 | | | | | | |

As shown in Table 2, in all the lithium secondary batteries according to the examples, it was found that the capacity retention rate was equal to or superior to those of the lithium secondary batteries according to the comparative examples even after being left at a high temperature (60° C.) for 24 weeks. In addition, in Comparative Example 3 in which 3 vol % of difluoroethyl acetate was contained, it was confirmed that the high-temperature storage characteristics were significantly deteriorated compared to those in the examples. In summary, the lithium secondary battery according to an exemplary embodiment of the present disclosure may have a high energy density of 700 Wh/L or more and excellent high-temperature storage characteristics, and may also have significantly improved lifespan characteristics during rapid charging.

As set forth above, the lithium secondary battery according to the present disclosure may simultaneously satisfy a high energy density, excellent high-temperature storage characteristics, and excellent rapid charging lifespan characteristics. Specifically, the lithium secondary battery according to an exemplary embodiment may implement an energy density of 700 Wh/L or more, may have significantly excellent lifespan characteristics during rapid charging, and may maintain an excellent capacity retention rate during high-temperature storage.

Hereinabove, although the present disclosure has been described by specific matters and limited exemplary embodiments, they have been provided only for assisting in the entire understanding of the present disclosure. Therefore, the present disclosure is not limited to the exemplary embodiments. Various modifications and changes may be made by those skilled in the art to which the present disclosure pertains from this description.

Therefore, the spirit of the present disclosure should not be limited to the described exemplary embodiments, but the claims and all modifications equal or equivalent to the claims are intended to fall within the spirit of the present disclosure.

What is claimed is:

1. A lithium secondary battery comprising:
a positive electrode;
a negative electrode facing the positive electrode and including a silicon-based negative electrode active material; and
a non-aqueous electrolyte containing a non-aqueous organic solvent including a di-fluoro-based organic solvent and a lithium salt,
wherein a content of the di-fluoro-based organic solvent is 5 to 20 vol % with respect to a total volume of the non-aqueous organic solvent.

2. The lithium secondary battery of claim 1, wherein the silicon-based negative electrode active material is Si, SiOₓ (O<x<2), Si/C, SiO/C, or a combination thereof.

3. The lithium secondary battery of claim 2, wherein the silicon-based negative electrode active material is included in the negative electrode in an amount of 5 to 20 wt %.

4. The lithium secondary battery of claim 1, wherein the non-aqueous organic solvent further includes a linear carbonate-based solvent and a cyclic carbonate-based solvent.

5. The lithium secondary battery of claim 4, wherein the linear carbonate-based solvent is one or two or more selected from dimethyl carbonate, diethyl carbonate, ethyl methyl carbonate, and methyl propyl carbonate.

6. The lithium secondary battery of claim 4, wherein the cyclic carbonate-based solvent is one or two or more selected from ethylene carbonate, propylene carbonate, and trimethylene carbonate.

7. The lithium secondary battery of claim 4, wherein the linear carbonate-based solvent and the di-fluoro-based organic solvent are contained in a volume ratio of 1:0.1 to 1:1.

8. The lithium secondary battery of claim 1, wherein the non-aqueous electrolyte further contains an additive containing fluoroethylene carbonate.

9. The lithium secondary battery of claim 8, wherein the fluoroethylene carbonate is contained in an amount of more than 3 wt % and 10 wt % or less with respect to a weight of the non-aqueous electrolyte.

10. The lithium secondary battery of claim 8, wherein the fluoroethylene carbonate and the di-fluoro-based organic solvent are contained in a volume ratio of 1:1 to 1:5.

11. The lithium secondary battery of claim 1, wherein the di-fluoro-based organic solvent is a di-fluoro-based acetate solvent.

12. The lithium secondary battery of claim 1, wherein a content of the di-fluoro-based organic solvent is 7 to 15 vol %.

13. The lithium secondary battery of claim 1, wherein the di-fluoro-based organic solvent is represented by the following Chemical Formula 1: 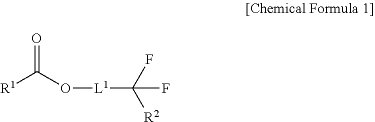
wherein
R¹ is C₁-C₆ alkyl or C₆-C₁₂ aryl;
L¹ is a single bond, C₁-C₆ alkylene, or C₂-C₆ alkenylene; and
R² is hydrogen, C₁-C₆ alkyl, or C₂-C₆ alkenyl.

14. The lithium secondary battery of claim 13, wherein the di-fluoro-based organic solvent is represented by the following Chemical Formula 2:

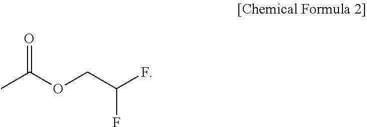

15. The lithium secondary battery of claim 1, wherein the lithium salt is one or two or more selected from LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiN(CₓF₂ₓ₊₁SO₂) (CyF_{2y+1}SO₂) (where x and y are natural numbers), LiCl, LiI, and LiB(C₂O₄)₂.

16. The lithium secondary battery of claim 1, wherein a capacity retention rate of the lithium secondary battery is 80% or more when rapid charge and discharge cycles are repeated 300 times at a temperature of 25° C.

17. The lithium secondary battery of claim 16, wherein a capacity retention rate of the lithium secondary battery is 80% or more when left for 20 weeks at a temperature of 60° C.
